(19) United States
(12) Patent Application Publication
(10) Pub. No.: US 2015/0057583 A1
(43) Pub. Date: Feb. 26, 2015

(54) TRABECULAR MESHWORK STIMULATION DEVICE

(71) Applicant: ALCON RESEARCH, LTD., Fort Worth, TX (US)

(72) Inventors: Nicholas Max Gunn, Newport Beach, CA (US); Andrew David Johnson, Tustin, CA (US); Casey Jean Lind, Orange, CA (US); Robert Joseph Sanchez, JR., Oceanside, CA (US)

(73) Assignee: ALCON RESEARCH, LTD., Fort Worth, TX (US)

(21) Appl. No.: 13/975,312

(22) Filed: Aug. 24, 2013

(51) Int. Cl. A61H 5/00; A61H 23/02

(52) U.S. Cl. CPC A61H 5/00; A61H 23/02
USPC 601/48; 601/46

(57) ABSTRACT

An implantable device for mechanically stimulating the trabecular meshwork is disclosed. The device is implanted in the eye adjacent the trabecular meshwork. The device imparts mechanical stimulating in the form of vibrations or movement to the trabecular meshwork. The imparted mechanical stimulation causes the trabecular meshwork to move in a manner that produces a pumping action to remove aqueous from the anterior chamber of the eye.

### BACKGROUND OF THE INVENTION

The present invention relates to a treatment for glaucoma and more particular to a method and apparatus for stimulating the trabecular meshwork of the eye to facilitate aqueous outflow.

Glaucoma, a group of eye diseases affecting the retina and optic nerve, is one of the leading causes of blindness worldwide. Glaucoma results when the intraocular pressure (TOP) increases to pressures above normal for prolonged periods of time. IOP can increase due to an imbalance of the production of aqueous humor (also referred to herein as “aqueous” or aqueous fluid”) and the drainage of the aqueous humor. Left untreated, an elevated IOP causes irreversible damage to the optic nerve and retinal fibers resulting in a progressive, permanent loss of vision.

The eye's ciliary body epithelium constantly produces aqueous humor, the clear fluid that fills the anterior chamber of the eye (the space between the cornea and iris). The aqueous humor flows out of the anterior chamber through the trabecular meshwork, Schlemm's canal, and collector channels as well as the uveoscleral pathways, a complex drainage system. The delicate balance between the production and drainage of aqueous humor determines the eye's IOP.

Open angle (also called chronic open angle or primary open angle) is the most common type of glaucoma. With this type, even though the anterior structures of the eye appear normal, aqueous fluid builds within the anterior chamber, causing the IOP to become elevated. Left untreated, this may result in permanent damage of the optic nerve and retina. Eye drops are generally prescribed to lower the eye pressure. In some cases, surgery is performed if the IOP cannot be adequately controlled with eye drops.

Only about 10% of the population suffers from acute angle closure glaucoma. Acute angle closure occurs because of an abnormality of the structures in the front of the eye. In most of these cases, the space between the iris and cornea is more narrow than normal, leaving a smaller channel for the aqueous humor to pass through. If the flow of aqueous humor becomes completely blocked, the IOP rises sharply, causing a sudden angle closure attack.

Secondary glaucoma occurs as a result of another disease or problem within the eye such as: inflammation, trauma, previous surgery, diabetes, tumor, and certain medications. For this type, both the glaucoma and the underlying problem must be treated.

FIG. 1 is a diagram of the front portion of an eye that helps to explain the processes of glaucoma. In FIG. 1, representations of the lens 110, cornea 120, iris 130, ciliary bodies 140, ciliary muscle 145, trabecular meshwork 150, and Schlemm's canal 160 are pictured. Anatomically, the anterior chamber of the eye includes the structures that cause glaucoma. Aqueous humor is produced by the ciliary bodies 140 that lie beneath the iris 130 and adjacent to the lens 110 in the anterior chamber. This aqueous humor washes over the lens 110 and iris 130 and flows to the drainage system located in the angle of the anterior chamber. The angle of the anterior chamber, which extends circumferentially around the eye, contains structures that allow the aqueous humor to drain. The first structure, and the one most commonly implicated in glaucoma, is the trabecular meshwork 150. The trabecular meshwork 150 extends circumferentially around the anterior chamber in the angle. The trabecular meshwork 150 may act as a filter, limiting the outflow of aqueous humor and providing a back pressure producing intraocular pressure (“IOP”). Schlemm's canal 160 is located beyond the trabecular meshwork 150. Schlemm's canal 160 has collector channels that allow aqueous humor to flow out of the anterior chamber. The two arrows in the anterior chamber of FIG. 1 show the flow of aqueous humor from the ciliary bodies 140, over the lens 110, over the iris 130, through the trabecular meshwork 150, and into Schlemm's canal 160 and its collector channels.

### SUMMARY OF THE INVENTION

The present disclosure describes several examples of the invention. In one example, a method of treating glaucoma is disclosed, the method comprises imparting vibrations to the trabecular meshwork from within an eye to produce a pumping action that removes aqueous from the anterior chamber of the eye.

In another example a method of treating comprises providing a device that produces mechanical vibrations; placing the device in an eye adjacent to the trabecular meshwork; and mechanically stimulating the trabecular meshwork with the vibrations.

In this example, the frequency and/or amplitude of the vibrations may be varied. The device may be placed in the eye by injecting it through a corneal incision. In some cases, the device is provided with a mass-spring system. The mass-spring system has a resonance that amplifies natural fluctuations in the eye. Examples of natural fluctuations include: movement of the body, movement of the eye, blinking, blood flow, aqueous drainage, and pressure changes. In other cases, the device is provided with an actuator to produce the vibrations. The actuator may be powered internally through batteries or externally through RF power harvesting or through electromagnetic/magnetic actuation. Mechanically stimulating the trabecular meshwork produces movement in the trabecular meshwork that acts to pump aqueous from the eye.

An exemplary device comprises: a supporting structure configured to be implanted in an anterior chamber of an eye and reside adjacent to the trabecular meshwork; and a vibrating structure carried on or integrated with the supporting structure, the vibrating structure configured to impart mechanical stimulation to the trabecular meshwork. In some case, the supporting structure is a flexible ring. In other cases, the supporting structure is a haptic of an intraocular lens. The actuator may be powered internally through batteries or externally through RF power harvesting or through electromagnetic/magnetic actuation. In one example, the vibrating structure is a mass-spring system. The mass-spring system resonates to amplify natural fluctuations in the eye. The natural fluctuations in the eye may be, for example, body movement, movement of the eye, blinking, blood flow, aqueous drainage, and pressure changes. In other examples, the vibrating structure is an actuator.

It is to be understood that both the foregoing general description and the following detailed description are exemplary and explanatory only and are intended to provide further explanation of the invention as claimed. The following description, as well as the practice of the invention, set forth and suggest additional advantages and purposes of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a diagram of the front portion of an eye.

FIG. 2 is a diagram of the front portion of the eye with an exemplary treatment area highlighted to explain a method of treating the eye consistent with the principles of the present invention.

FIG. 3A is a diagram of a ring-shaped device in an unflexed configuration according to the principles of the present invention.

FIG. 3B is a diagram of a ring-shaped device in a flexed configuration according to the principles of the present invention.

FIG. 4 is a diagram of an intraocular lens-type device according to the principles of the present invention.

FIG. 5 is a perspective view of an eye with an exemplary treatment region according to the principles of the present invention.

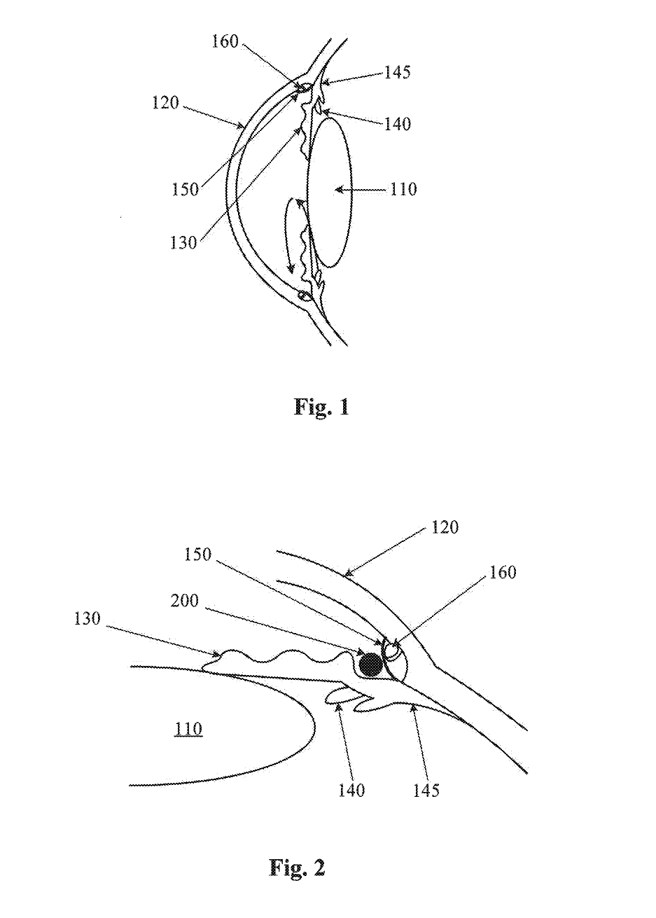

### DETAILED DESCRIPTION OF THE PREFERRED EMBODIMENTS

Reference is now made in detail to the exemplary embodiments of the invention, examples of which are illustrated in the accompanying drawings. Wherever possible, the same reference numbers are used throughout the drawings to refer to the same or like parts.

FIG. 2 is a diagram of the front portion of the eye with the treatment area highlighted to explain a device for and method of treating the eye consistent with the principles of the present invention. In FIG. 2, representations of the lens 110, cornea 120, iris 130, ciliary bodies 140, ciliary muscle 145, trabecular meshwork 150, and Schlemm's canal 160 are pictured. In addition, device 200 is located at the treatment site. The device 200 is located adjacent the trabecular meshwork 150 and/or the ciliary muscle 145. The device 200 imparts mechanical vibrations, movement, or stresses to the trabecular meshwork 150. As trabecular meshwork 150 is mechanically stimulated, it moves. Movement of the trabecular meshwork 150 produces a shear stress on the trabecular meshwork 150. This shear stress causes the trabecular meshwork 150 to generate cytokines. Cytokine production in the trabecular meshwork 150 leads to an increase in the flow of aqueous humor through the trabecular meshwork 150 and into Schlemm's canal 160 thus reducing IOP.

In addition or in the alternative, the device 200 stimulates the ciliary muscle 145 so that it moves. Since the ciliary muscle 145 is attached to the trabecular meshwork 150, movement of the ciliary muscle 145 produces a shear stress on the trabecular meshwork 150. This shear stress causes the trabecular meshwork 150 to generate cytokines. Cytokine production in the trabecular meshwork 150 leads to an increase in the flow of aqueous humor through the trabecular meshwork 150 and into Schlemm's canal 160 thus reducing intraocular pressure (“IOP”).

In another exemplary embodiment of the present invention, device 200 imparts a vibration to the trabecular meshwork 150 so that the trabecular meshwork 150 pumps aqueous. In this example, the mechanical vibrations produced by device 200 cause the trabecular meshwork 150 to move between two different positions thus acting as a pump or producing a pumping action that removes aqueous from the anterior chamber of the eye. The amplitude and frequency of the vibrations can be selected so as to impart a pumping action to the trabecular meshwork. For example, the frequency of the vibrations can be between one and 1,000 Hertz. Amplitudes on the order of 1 to 1,000 micrometers may also be employed. In this manner, the trabecular meshwork 150 can be made to move in a rhythmic motion at a set amplitude or distance. In other exemplary embodiments, the frequency and/or amplitude can be varied so as to vary the movement of the trabecular meshwork 150. For example, some eyes may respond to relatively low frequencies. In such a case, the frequency produced by device 200 can be adapted to a particular eye. Likewise, some eyes may respond to relatively high amplitudes. In such a case, the amplitude of the vibrations produced by device 200 can be adapted to a particular eye.

In some cases, the trabecular meshwork 150 of an eye may stiffen over time or over the progression of the glaucoma disease state. A stiffer trabecular meshwork 150 is more resistant to normal movement that facilitates the outflow of aqueous. Normal fluctuations of IOP cause movement of the trabecular meshwork 150 that acts to pump aqueous out of the anterior chamber. Movements of the body or the vasculature may also cause natural movement of the trabecular meshwork 150. However, in an eye with glaucoma, the trabecular meshwork 150 becomes stiff or rigid and is not able to move as freely. In such a case, device 200 provides mechanical stimulation that serves to restore a more normal movement of the trabecular meshwork 150 to facilitate the removal of aqueous from the anterior chamber.

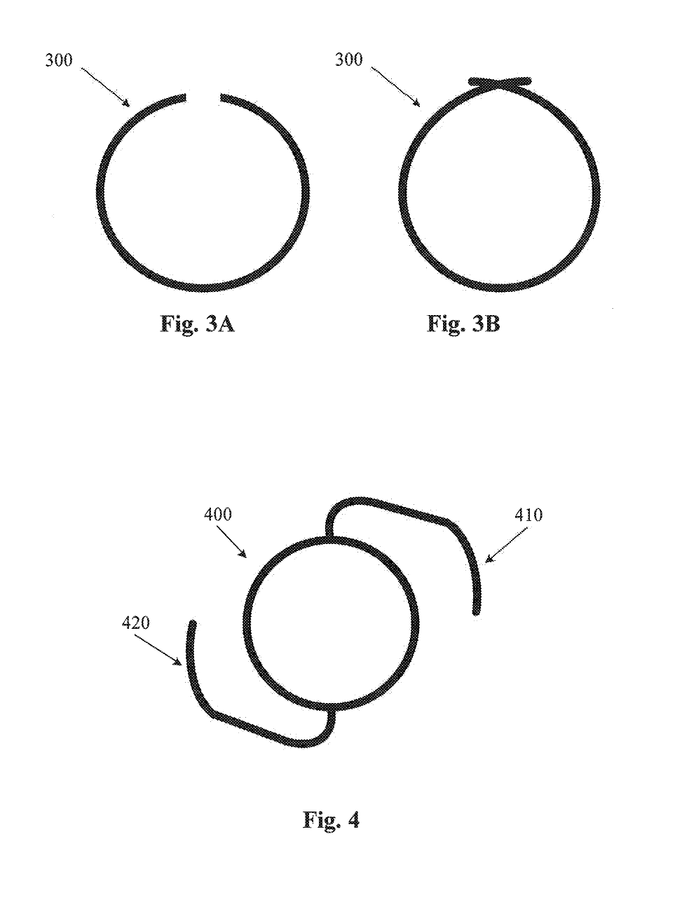

In FIG. 2, device 200 is shown in cross section. In this example, device 200 is a ring or partial ring with a cylindrical cross section. Of course, other cross section shapes may be employed without departing from the principles of the present invention. For example, elliptical, square or polygonal cross sections may be employed. The ring configuration is more clearly shown in FIGS. 3A and 3B.

FIG. 3A is a diagram of a ring-shaped device in an unflexed configuration according to the principles of the present invention. FIG. 3B is a diagram of a ring-shaped device in a flexed configuration according to the principles of the present invention. The device of the example shown in FIGS. 3A and 3B may be made of nitinol or titanium. The device 300 may be implanted in the eye in an ab interno procedure. When implanted, device 300 resides around the periphery of the anterior chamber in the angle adjacent the trabecular meshwork. While shown as a ring that is located around the entire periphery of the anterior chamber, device 300 could be arc-shaped such that the device 300 only resides around a subset of the periphery of the anterior chamber. For example, device 300 could be such that it resides adjacent the trabecular meshwork over 180 degrees of the periphery of the anterior chamber.

In operation, the exemplary device 300 of FIGS. 3A and 3B may oscillate between a flexed and unflexed position so as to impart movement to the trabecular meshwork. As such, the device 300 may impart a vibratory motion to the trabecular meshwork. In another example, device 300 may be implanted in the eye in a flexed position. After implantation, device 300 becomes unflexed and presses against the trabecular meshwork. In this example, device 300 is held securely against the trabecular meshwork. Device 300 may then vibrate to impart vibratory motion to the trabecular meshwork.

FIG. 4 is a diagram of an intraocular lens-type device according to the principles of the present invention. In FIG. 4, an intraocular lens (IOL) has two haptics 410 and 420 that incorporate a vibration device. In this manner, the haptics 410 and 420 are capable of imparting vibrations or movement to eye structures such as the ciliary muscle and/or the trabecular meshwork. The vibrational components described herein can be incorporated into haptics 410 and 420. When the IOL 400 is implanted, the haptics 410 and 420 are located in the angle of the anterior chamber adjacent the trabecular meshwork. The haptics 410 and 420 press against the trabecular meshwork to hold the IOL in place in the eye. The device 400 may be implanted in the eye through a corneal incision.

Regardless of the configuration of the device, the device would excite the TM through localized mechanical vibration. This can be done passively through a resonant interaction, amplifying the natural fluctuations present in the eye (such as fluctuations caused by movement of the body, movement of the eye, blinking, blood flow, aqueous drainage, pressure changes, etc.) This approach could incorporate a mechanical resonator(s), such as a simple damped mass-spring system, imbedded in the device. MEMS based mass-spring systems, such as accelerometers, may be employed. The implant can be designed to resonate at the cardiac frequency (typically seen in intraocular pressure fluctuation). If a mass-spring system is employed, the mass and spring components may be located in the ring device 300 of FIGS. 3A and 3B or in the haptics 410 and 420 of FIG. 4. In this example, the mass-spring system is a vibrating structure and the ring (FIGS. 3A & 3B) or the haptics (FIG. 4) are supporting structures.

Alternatively, the mechanical vibration can be actively driven by a supporting device, also located either internally or externally. This may also be integrated with a configuration that operates passively but can be tuned actively, as needed, for improved performance. For example, an actuator may be employed to create or amplify the vibrations produced by the device. Such an actuator may be incorporated into the device. In this example, the actuator is a vibrating structure. In other embodiments, the device may be excited to any given frequency through use of an external device employing electromagnetic/magnetic actuation to drive the resonant movement.

In operation, the exemplary devices described herein may be activated for fixed periods of time if actively controlled or for periods of time defined by the type of passive resonance employed. The use case may be programmed by the doctor to tailor the treatment to match the patient's specific needs.

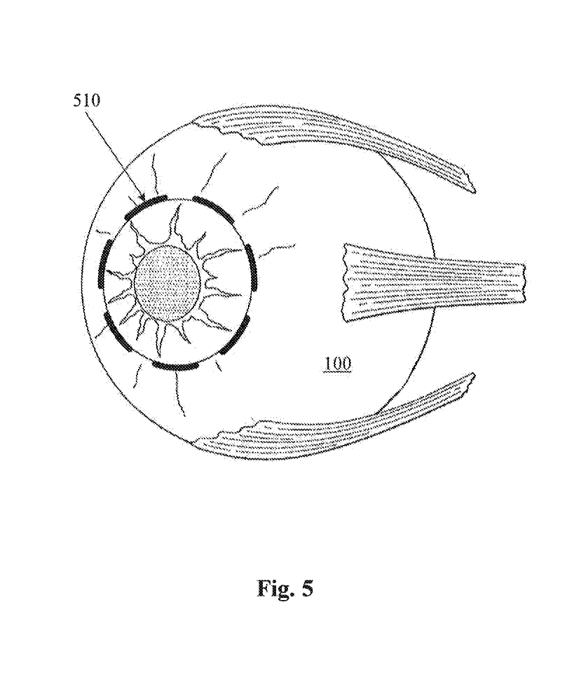

FIG. 5 is a perspective view of an eye with an exemplary treatment region according to the principles of the present invention. Eye 100 and treatment region 510 are shown. Treatment region 510 is located around the periphery of the anterior chamber adjacent the trabecular meshwork and/or ciliary body.

From the above, it may be appreciated that the present invention provides a method and system for treating glaucoma. The present disclosure describes a device that imparts mechanical stimulus (for example, vibratory motion or other movement) to the trabecular meshwork. This mechanical stimulus causes the trabecular meshwork to move in a manner that facilitates outflow of aqueous, for example, through a pumping action. Alternatively, the present disclosure describes a device that mechanically stimulates the ciliary muscle. Since the ciliary muscle is attached to the trabecular meshwork, movement of the ciliary muscle produces a shear stress on the trabecular meshwork. This shear stress causes the trabecular meshwork to generate cytokines. Cytokine production in the trabecular meshwork leads to an increase in the flow of aqueous humor through the trabecular meshwork and into Schlemm's canal thus reducing IOP. The present invention is illustrated herein by example, and various modifications may be made by a person of ordinary skill in the art.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of treating glaucoma comprising:
imparting vibrations to the trabecular meshwork from within an eye to produce a pumping action that removes aqueous from an anterior chamber of the eye.

2. A method of treating glaucoma comprising:
providing a device that produces mechanical vibrations;
placing the device in an eye adjacent a trabecular meshwork; and
mechanically stimulating the trabecular meshwork with the vibrations.

3. The method of claim 2 wherein a frequency of the vibrations is varied.

4. The method of claim 2 wherein an amplitude of the vibrations is varied.

5. The method of claim 2 wherein placing the device adjacent the trabecular meshwork further comprises:
injecting the device through a corneal incision.

6. The method of claim 2 wherein providing a device that produces mechanical vibrations further comprises:
providing a device with a mass-spring system, the mass-spring system with a resonance that amplifies natural fluctuations in the eye.

7. The method of claim 6 wherein the natural fluctuations in the eye are selected from the group consisting of: movement of the body, movement of the eye, blinking, blood flow, aqueous drainage, and pressure changes.

8. The method of claim 2 wherein providing a device that produces mechanical vibrations further comprises:
providing a device with actuator to produce the vibrations.

9. The method of claim 2 wherein mechanically stimulating the trabecular meshwork produces movement in the trabecular meshwork that acts to pump aqueous from the eye.

10. The method of claim 2 wherein mechanically stimulating the trabecular meshwork produces a pumping action in the trabecular meshwork that removes aqueous from the eye.

11. A device implantable in an eye, the device comprising:
a supporting structure configured to be implanted in an anterior chamber of an eye and reside adjacent a trabecular meshwork of the eye; and
a vibrating structure carried on or integrated with the supporting structure, the vibrating structure configured to impart mechanical stimulation to the trabecular meshwork.

12. The device of claim 11 wherein the supporting structure is a flexible ring.

13. The device of claim 11 wherein the supporting structure is a haptic of an intraocular lens.

14. The device of claim 11 wherein the vibrating structure is a mass-spring system.

15. The device of claim 14 wherein the mass-spring system is configured with a resonance that amplifies natural fluctuations in the eye.

16. The device of claim 15 wherein the natural fluctuations in the eye are selected from the group consisting of: movement of the body, movement of the eye, blinking, blood flow, aqueous drainage, and pressure changes.

17. The device of claim 11 wherein the vibrating structure is an actuator.

18. The device of claim 17 wherein the actuator is programmable, allowing for customization of:
an on/off state;
a vibration amplitude; and
a vibration frequency.

19. The device of claim 17 wherein the actuator is driven by an external electromagnetic/magnetic device.
